(19) United States
(12) Patent Application Publication
(10) Pub. No.: US 2016/0253308 A1
(43) Pub. Date: Sep. 1, 2016

(54) ANALYSIS VIEW FOR PIVOT TABLE INTERFACING

(71) Applicant: MICROSOFT TECHNOLOGY LICENSING, LLC, Redmond, WA (US)

(72) Inventors: Mathew Olinger, Redmond, WA (US); Michael G. Davenport, Seattle, WA (US)

(21) Appl. No.: 14/634,594

(22) Filed: Feb. 27, 2015

(51) Int. Cl. G06F 17/24; G06F 3/0482; G06F 3/0481

(52) U.S. Cl. CPC G06F 17/246; G06F 3/04817; G06F 3/0482

(57) ABSTRACT

Various methods, systems and storage devices are used for creating and utilizing an analysis view for pivot table interfacing. The analysis view can be created with a visualization that reflects data summarized in the pivot table automatically in response to detecting user input directed at a particular data field (i.e., cell) of the pivot table and without requiring any additional user input, such as user input required to navigate a chart wizard or any other graphics interface. The visualization includes at least one selectable and transient object that is configured for being selected and dragged out of the analysis view window and which persists even after the analysis view window is closed, unless it is first dragged outside of the boundaries of the analysis view window and without requiring additional user input for separately closing and/or removing the transient object.

### BACKGROUND

Many types of computer applications exist to help users access and manipulate data, including spreadsheet applications. These applications can also be referred to simply as spreadsheets. Excel is one example of a spreadsheet.

A spreadsheet will typically present data in cells that are located within a grid of columns and rows. A spreadsheet can include a single worksheet or a compilation of worksheets in a workbook. Each cell in the spreadsheet can contain a specific value entered by a user, or a formula that defines a relative relationship to data contained within one or more other cells. When a formula is provided in a cell, the corresponding value is displayed to the user.

Sometimes, the data contained within a spreadsheet can be overwhelming and difficult to comprehend. Accordingly, various tools are provided for summarizing the data and relationships defined therein. A pivot table is one type of a data summarization tool that is found in spreadsheets and other data visualization programs, including some business intelligence software.

A pivot table can automatically sort, count, total or give the average of the data stored in one table or spreadsheet, displaying the results in a second table showing the summarized data. Pivot tables are also useful for quickly creating un-weighted cross-tabulations. A user can set up and change the summary structure by dragging and dropping fields graphically within the pivot table structure.

Some pivot table interfaces provide supplemental chart wizards for creating charts or other graphics associated with the data summarized by the pivot table summary.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

As described herein, various methods, systems and storage devices are provided for creating and utilizing an analysis view for pivot table interfacing.

In one embodiment, a computing system detects user input directed at a particular data field (i.e., cell) of a pivot table or another document containing a plurality of populated data fields. Then, upon determining that the particular data field comprises an aggregate value representing data from a plurality of separate data fields, the computing system generates a visualization that graphically reflects disparate elements of the aggregate value within an analysis view window.

In some embodiments, the generation of the visualization occurs automatically, without requiring any additional user input, such as user input required to navigate a chart wizard or any other graphics interface.

In another embodiment, user input is directed at a particular cell of a pivot table containing a value representing a plurality of separate data elements. Then, in response to detecting this user input, and in response to determining the particular data field comprises an aggregate value representing data from a plurality of separate data fields, the computing system generates a visualization that graphically represents the content from the separate data fields.

In some embodiments, the visualization includes at least one selectable and transient object that is configured for being selected and dragged out of the analysis view window and which persists even after the analysis view window is closed. Alternatively, the transient object is automatically closed and/or removed from display in response to closing the analysis view without requiring additional user input for separately closing and/or removing the transient object.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates an embodiment of a computing system which is usable to implement aspects of the disclosed embodiments for creating and utilizing an analysis view for pivot table interfacing;

FIGS. 2-8 illustrate various pivot table and analysis view interfaces associated with the disclosed embodiments for creating and utilizing an analysis view for pivot table interfacing;

FIG. 9 illustrates a flowchart of at least one method for creating and utilizing an analysis view for pivot table interfacing;

FIG. 10 illustrates another flowchart of at least one method for creating and utilizing an analysis view for pivot table interfacing; and

FIG. 11 illustrates another flowchart of at least one method for creating and utilizing an analysis view for pivot table interfacing.

### DETAILED DESCRIPTION

Aspects of the disclosed embodiments relate to the creation and use of analysis view interfaces and objects that can be used for interfacing with pivot tables.

While some pivot table interfaces currently exist, it can still be difficult for a user to comprehend how to navigate the data presented by a pivot table and how to create and/or utilize graphics for a pivot table.

In the present disclosure an analysis view is described, which is capable of improving the user experiences associated with pivot tables. The analysis view can be used in some embodiments to create graphics that are transient and that can be nimbly rotated in and out of view, along with other graphics, in response to simple gestures, without requiring a user to navigate through complex hierarchies of menus and chart wizards.

There are various technical effects and benefits that can be achieved by implementing aspects of the disclosed embodiments. By way of example, the disclosed embodiments can be used to provide a more intuitive and flexible interface for navigating pivot table data, which can reduce user interactions and processing associated with misdirected and incorrect requests for making desired modifications to pivot table data.

The disclosed embodiments can also be used to provide enhanced user convenience and experience when creating pivot table charts and other graphics, as well as to reduce user interactions and processing associated with misdirected and incorrect requests associated with the creation and deletion of pivot table graphics.

The technical effects related to the disclosed embodiments can also include improved user convenience and efficiency gains through a reduction in the processing required for maintaining and managing pivot table charts and graphics, particularly after a pivot table has been closed.

Various methods, computing systems and storage devices will now be described with reference to the disclosed embodiments for creating and utilizing an analysis view for interfacing with pivot tables.

In this description and in the claims, the term “computing system” is defined broadly as including any device or system (or combination thereof) that includes at least one physical and tangible processor, and a physical and tangible memory capable of having thereon computer-executable instructions that may be executed by the processor.

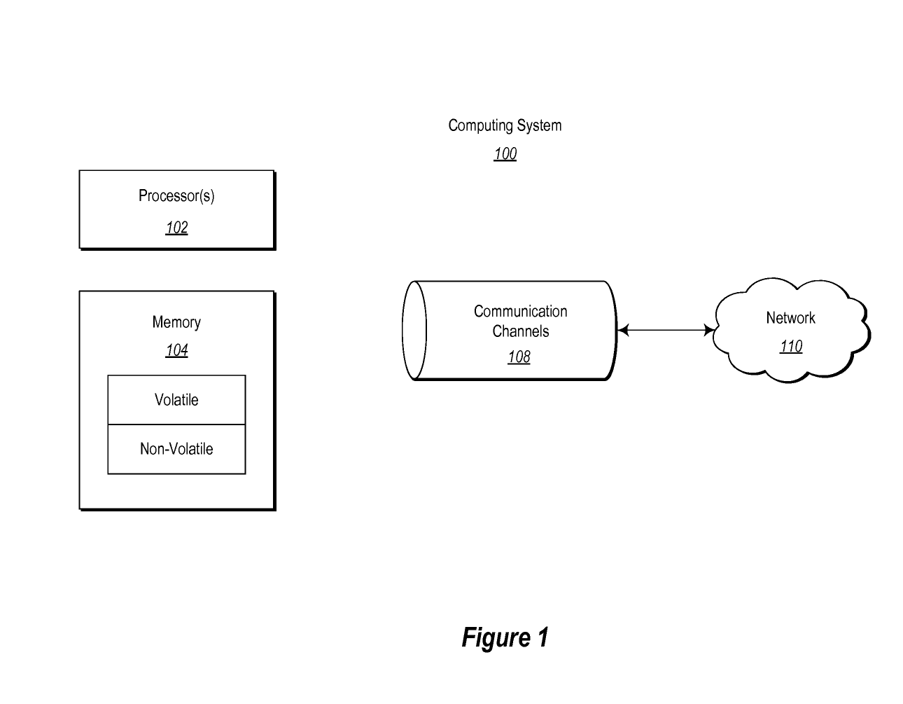

As illustrated in FIG. 1, in its most basic configuration, the computing system 100 includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100.

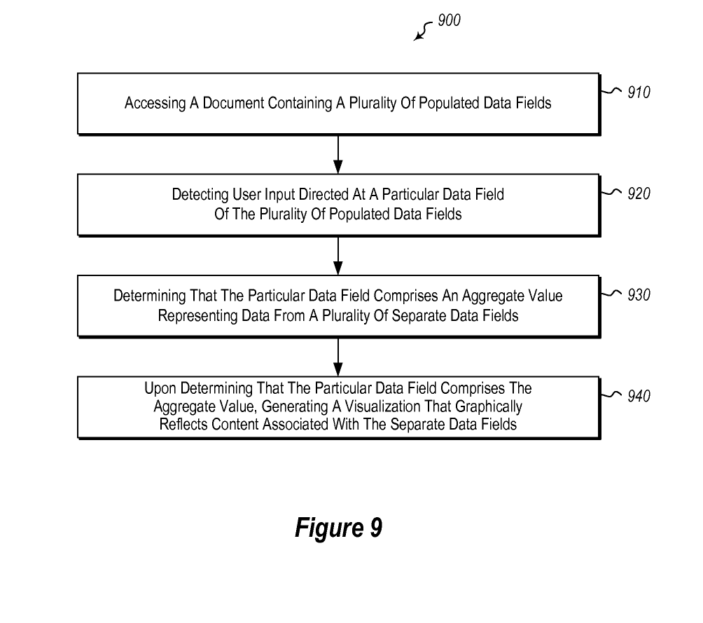

The computer-executable instructions may be used to implement and/or instantiate all of the disclosed functionality, particularly as disclosed in reference to the methods illustrated in the flow diagrams of FIGS. 9-11. The computer-executable instructions are also to implement and/or instantiate all of the interfaces disclosed herein, including the analysis view windows and graphics.

Computing system 100 may also contain communication channels 108 that allow the computing system 100 to communicate with other message processors over, for example, network 110.

Embodiments described herein may comprise or utilize special-purpose or general-purpose computer system components that include computer hardware, such as, for example, one or more processors and system memory. The system memory may be included within the overall memory 104. The system memory may also be referred to as “main memory,” and includes memory locations that are addressable by the at least one processing unit 102 over a memory bus in which case the address location is asserted on the memory bus itself System memory has been traditionally volatile, but the principles described herein also apply in circumstances in which the system memory is partially, or even fully, non-volatile.

Embodiments within the scope of this disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage devices that store computer-executable instructions and/or data structures. Physical hardware storage devices include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

When the referenced acts of the disclosed methods are implemented in software, the one or more processors 102 of the computing system 100 perform the acts and direct the operation of the computing system 100 in response to having executed the stored computer-executable instructions defined by the software. Various input and output devices, not illustrated, can be used by the computing system to receive user input and to display output in accordance with the computer-executable instructions.

Various methods for implementing the disclosed embodiments with a computing system, like computing system 100, will now be described.

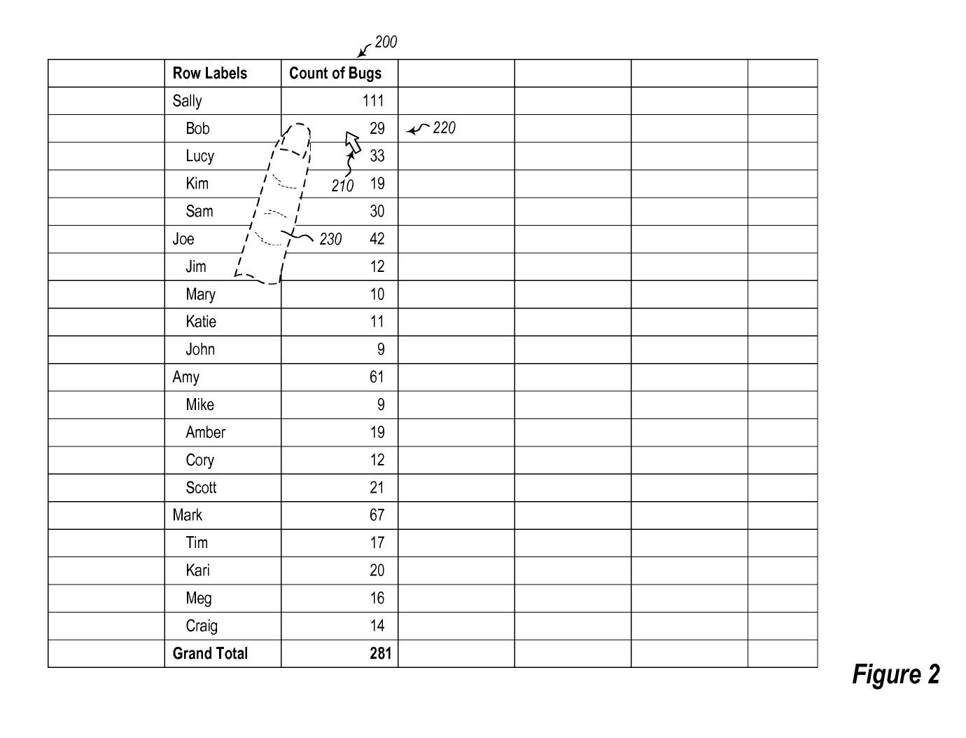

FIG. 2 illustrates one embodiment of a pivot table 200 corresponding to data contained in a spreadsheet. The pivot table 200 includes two columns of individual data fields or cells. The first column includes programmers, listed by name. The second column of data fields, includes values associated with one or more different types of detected programming bugs that have been identified in one or more different programs. Each value in the ‘Count of Bugs’ column represents an aggregate value associated with a plurality of separate data fields found within a spreadsheet.

This pivot table 200 may be created, for instance, for a spreadsheet that includes different sections of data associated with programming bugs that have been found for particular types and/or particular programs. Each of the different sections of data in the spreadsheet may be associated with a different dimension or context related to the bugs (e.g., program or feature type, current state, author, assignment, handling, and so forth). The contexts of the data in the spreadsheet, however, will depend on the specific needs and preferences of the client and the availability of the data that is being analyzed.

In general, once data is put into the data fields of a spreadsheet, a pivot table can be created to summarize that data, using known techniques. For instance, various pivot table interfaces currently exist for enabling a user to select the specific contexts that are to be summarized in a pivot table. These interfaces include pivot table wizards that enable a user to select a range of data to be summarized and the specific rows/columns to be aggregated and/or compared.

In FIG. 2, the user has configured the pivot table 200 to summarize data from one or more spreadsheets having individual data fields that define values associated with computer bugs related to different programmers. In the pivot table, this data has been summarized for each programmer, such that a total count of bugs is identified for each programmer (at a first level) and for each supervisor (at a higher level), across all types of programs and contexts associated with the programmers and bugs.

In this embodiment, different levels or contexts for summarizing the data is visually apparent. For instance, supervisors Sally, Joe, Amy and Mark are visually distinguished from the other programmers that they supervise. The total bugs that are associated with each of these supervisors is the total of all the bugs that are associated with all of the programmers they supervise. (e.g., Sally's bug total of 111 is the sum of Bob's 29, Lucy's 33, Kim's 19 and Sam's 30).

Once a pivot table is created, such as pivot table 200, a user may desire to visualize the summarized data in one or more charts or other graphics. Typically, a user has to open a separate chart wizard to do this. Then, the user has to navigate through the chart wizard to identify the different parameters that the user wants to be utilized in the corresponding chart. Sometimes, this process is very cumbersome. Also, once the chart is created and the chart wizard is closed, the chart continues to persist, even though it may not be desired. Accordingly, the user must perform additional actions to close the chart. If a user wants to change the layout or context of the chart, the user may also have to open a new instance of the chart wizard, thereby adding to the difficulty of interfacing with the pivot table.

The embodiments of the present disclosure can help to overcome some of these technical problems, which are specifically related to computer interfacing with pivot tables.

In some embodiments, for example, a user can automatically trigger the generation of an analysis view window having a graphic that intuitively represents the summarized data from the pivot table and/or one or more underlying dimensions of the data that is being summarized, and without requiring the user to navigate a separate chart/graphics wizard. The images and graphics that are created by the analysis view window are also created to be transient, such that they are automatically removed when the analysis view window is closed, thereby helping to reduce storage requirements associated with the spreadsheet document.

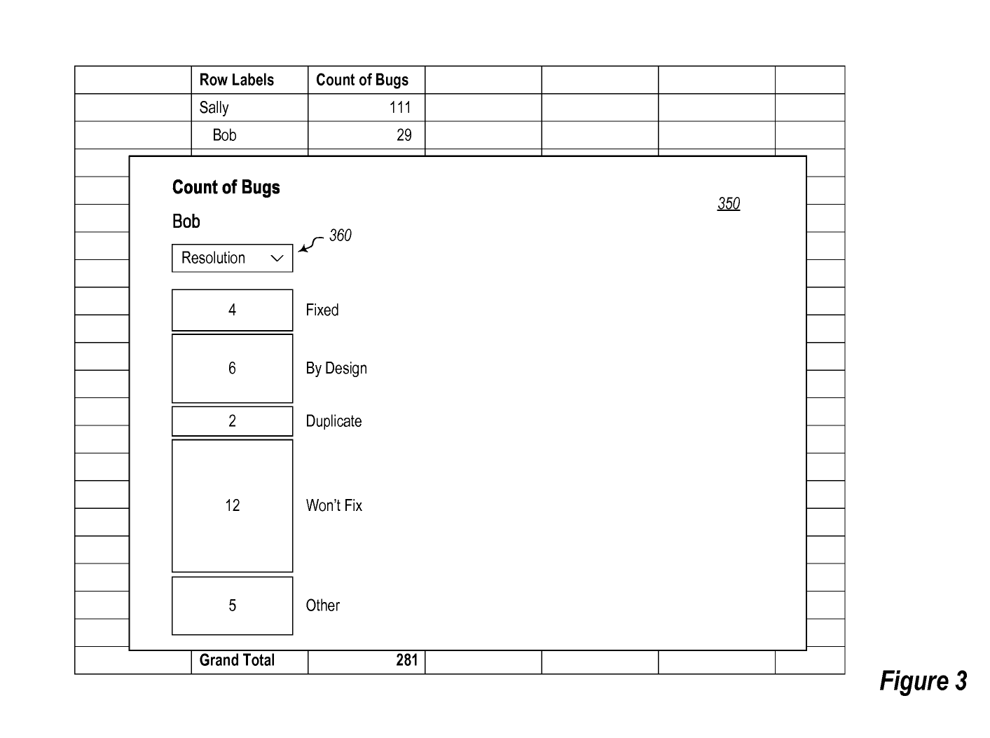

Various examples of the analysis view window will now be provided with respect to illustrations presented in FIGS. 3-8. These embodiments will also be described with reference to the methods that are illustrated by the flowcharts of FIGS. 9-11.

The flowchart 900 of FIG. 9, for instance, illustrates a method that starts out when a computing system accesses a document containing a plurality of populated data fields (act 910). This document may comprise a pivot table, a spreadsheet or any other data visualization document.

Next, the method includes the computing system detecting user input, such as a gesture, directed at a particular data field (act 920). This may include, for example, a user positioning or hovering a cursor over a cell in a pivot table, or by touching (with a touch screen) the cell of a pivot table. FIG. 2, for instance, shows a cursor 210 that is hovering over cell 220. A finger 230 can also be used to touch the cell 220.

While specific inputs have been described. Other gestures can also be used to provide the requisite input. For instance, a finger or cursor can be used to swipe within a cell, to select and hold within a cell for a predetermined period of time (e.g., a few seconds), to double-click the cell, select a menu icon after the cell is selected, dragging the cell onto a graphics icon, selection of a visualization icon or menu option that is automatically presented in response to detecting a cursor positioned over the particular data field and/or any other appropriate gesture. The type of gesture used can vary to accommodate different needs and preferences.

Once an appropriate gesture/input is received, the system determines that the particular data field that was selected by the input comprises an aggregate value that represents data from a plurality of separate data fields (act 930). This determination can be made by parsing the cell and or by referencing the data source(s) for the cell.

In the present instance, cell 220 of FIG. 2 includes a value of twenty nine (29), which is an aggregate value corresponding to the various different types of bugs that are associated with programmer Bob. Each of these different types of bugs are separately identified in other data fields of the spreadsheet (not shown).

Next, in response to the determination that the data field represents an aggregate value, the system generates a visualization that graphically reflects the content associated with the separate data fields (act 940).

FIG. 3 illustrates one example of an analysis view window 350 that is automatically created (corresponding to act 940) in response to detecting that a user selected a cell in a pivot table (corresponding to acts 910 and 920) and that contains an aggregate value corresponding to a plurality of separate data fields (corresponding to act 930).

As shown, the analysis view window 350, also referred to herein more simply as the analysis view, can be configured to generate an initial type of graphic (e.g., decomposition chart, timeline, pie chart, bar chart, scatter plot and/or any other graphic) based on default settings or user preferences. In some instances, these settings are also based on user profiles and detected patterns associated with a current user and/or one or more users, such as, for example, by examining historical data and/or by determining which graphic is most commonly created for or used with a pivot table having similar attributes to the current pivot table by the user(s).

In the analysis view 350 of FIG. 3, the count of bugs for Bob is visually illustrated by a decomposition chart that identifies how many bugs of a particular resolution exist for Bob.

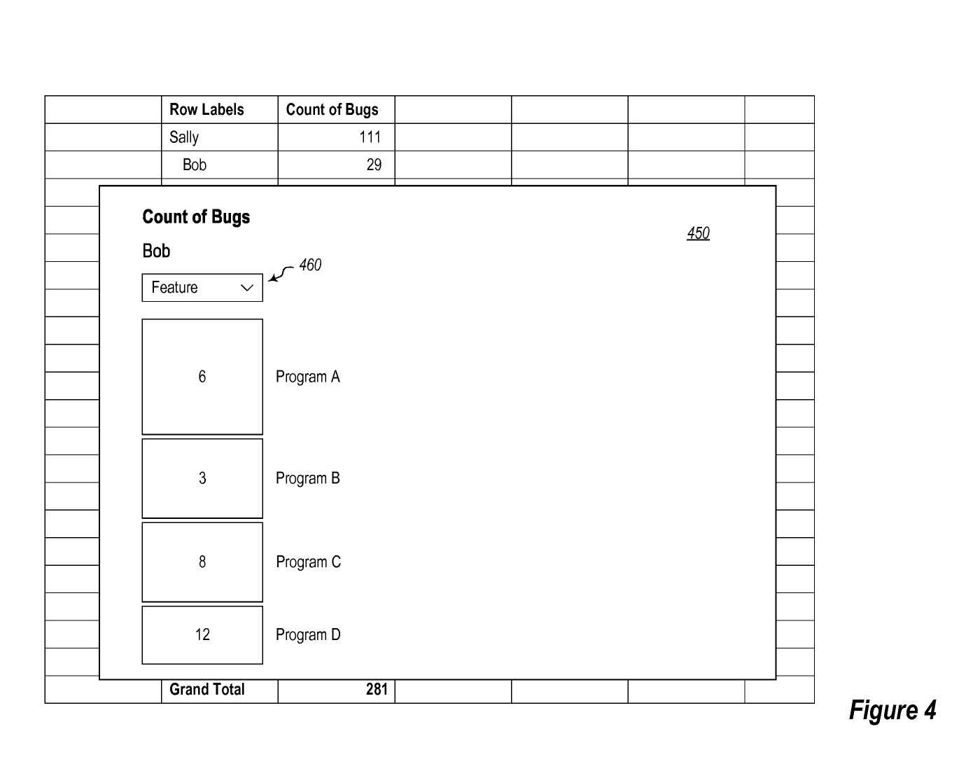

The dimension or context of the bugs being visualized can also be rendered by the analysis view in response to a user selecting a menu option, such as an option from pull down menu 360, to display bugs by a selected dimension (e.g., feature). An example of a newly rendered visualization in response to this user input is reflected by the analysis view 450 of FIG. 4.

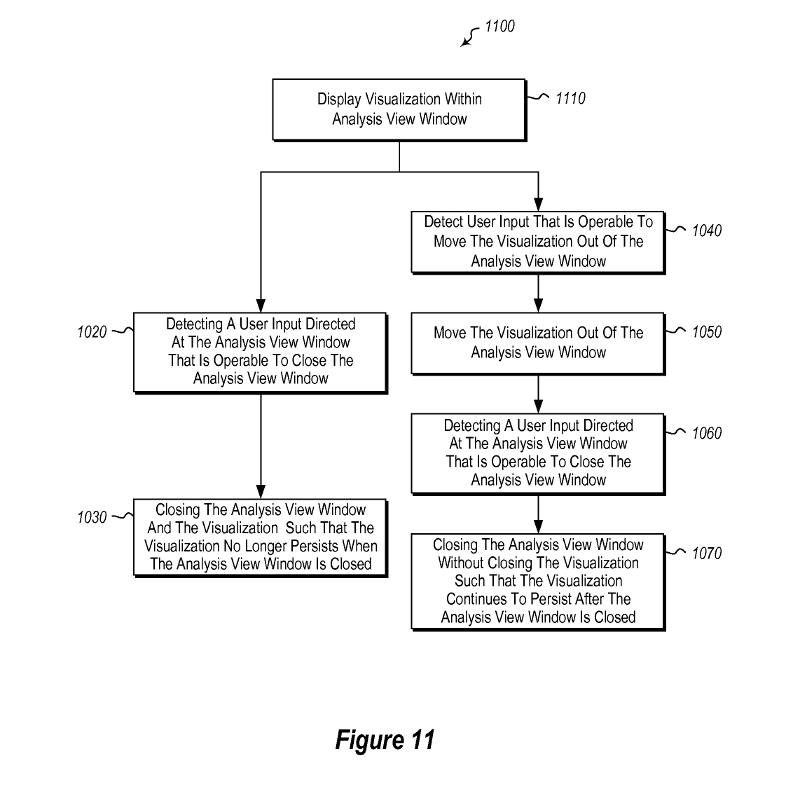

Notably, the first visualization shown by analysis view 350 is transient, such that it is deleted automatically in response to receiving user input at menu 360 to display the feature view/context shown in FIG. 4, and without requiring any additional user input. This can be beneficial for reducing user inputs and processing required by the computing system. Such an embodiment is also described in more detail below, with reference to FIG. 11.

It will also be appreciated that the user can select any other type of context or view from the pull down menu 460, in order to trigger the rendering of other visualization types. In some embodiments, a plurality of different visualizations can be simultaneously displayed within the analysis view window and without requiring the user to open a new chart wizard for each visualization.

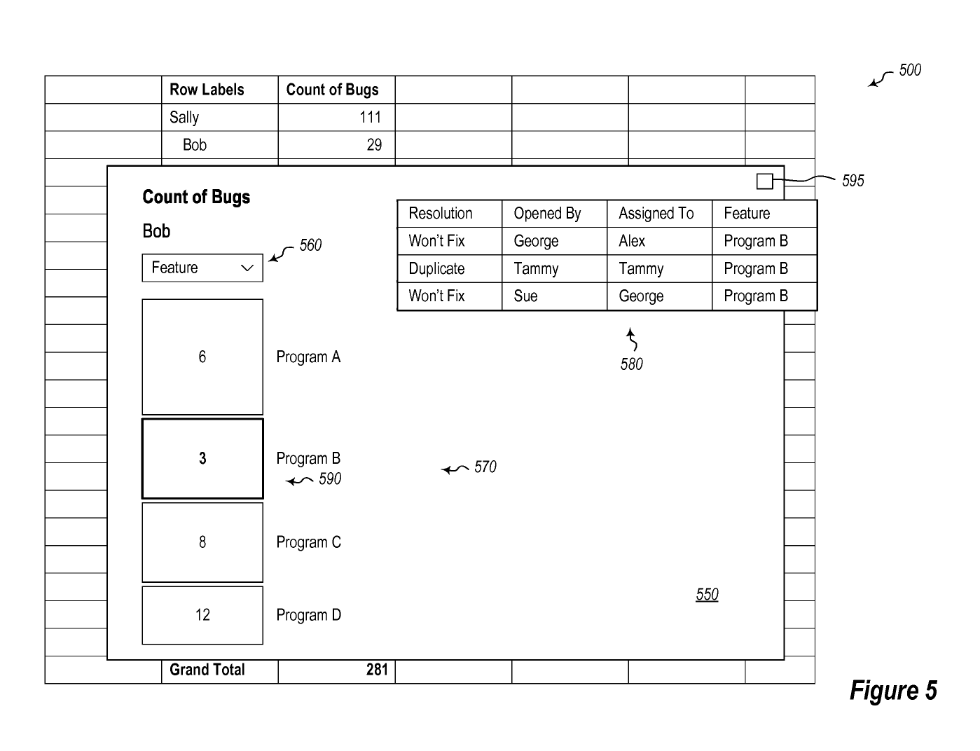

FIG. 5 illustrates an analysis view 550 having a plurality of visualizations. These visualizations include a decomposition chart 570 and a matrix type chart 580 that corresponds to the three (3) bugs associated with the feature of Program B.

The presentation of the second visualization (e.g., chart 580) can be triggered by a separate gesture or user input. For instance, the user can select and hold, double click on, direct focus to, swipe or otherwise select an object displayed in the first visualization. In this case, the user has selected the object box 590 or selected the label Program B next to box 590.

When the user closes the analysis view window 550, such as by selecting a menu option or icon (e.g., icon 595), both of the visualizations are automatically closed with the analysis view 500. The analysis view window 550 can also be closed in response to a gesture, such as a swipe of the analysis view window, either horizontally or vertically.

The visualizations are considered transient because they are automatically closed with the analysis view. However, if the user desires to keep one or more of these visualizations, the user can select and drag the visualization out of the analysis view window 550 before the analysis view is closed, causing the visualization to persist. In the present case, the user has begun dragging the second visualization (e.g., chart 580 out of the analysis view 550). Once it is fully dragged out of the boundaries of the analysis view frame, the visualization will persist after the analysis view is closed. Otherwise, it will be closed with the analysis view.

The computing system recognizes and tracks the boundaries of the analysis view and the boundaries of the visualizations. The computing system also initiates a write operation to save the visualization into the position where it is moved, once the visualization is completely moved outside of the boundaries of the analysis view. Various other inputs and gestures can also be used to initiate the saving and/or persisting of the different visualizations.

Various gestures and inputs can also be used to automatically change the presentation of the visualizations within the analysis view. For instance, a user can perform a quick swipe gesture of the visualization in a horizontal or vertical direction to automatically cause the computing system to generate or show a new visualization of a new type for the same context/dimensions or a new context/dimension. A user may also select the new context or dimension from a menu option, such as a menu option presented within menu 560.

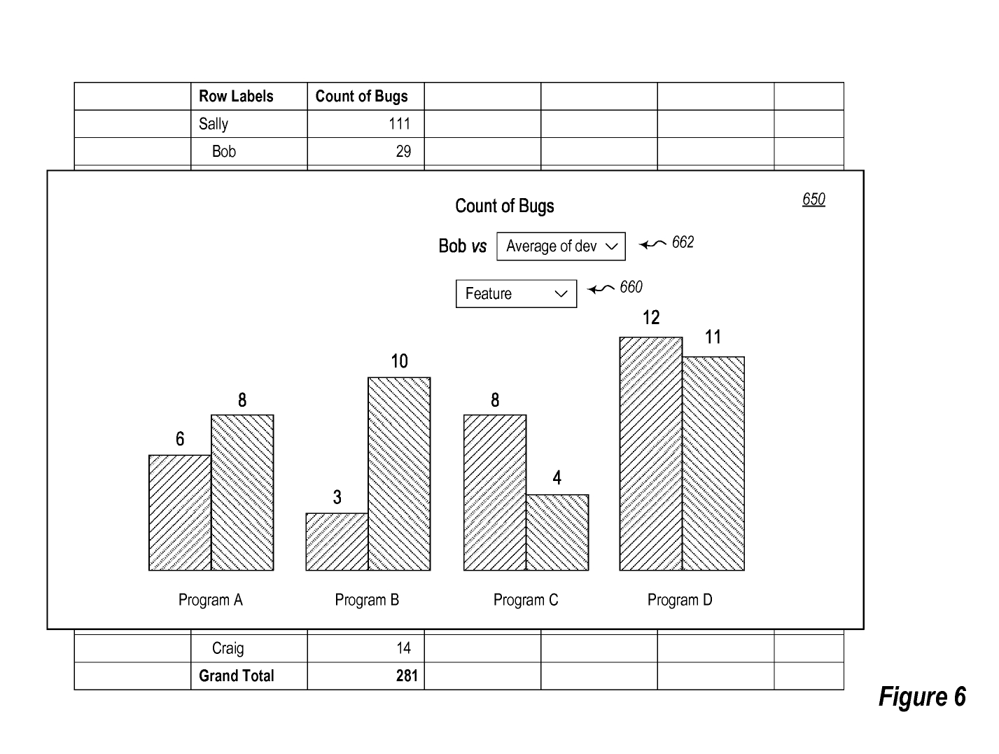

FIG. 6 illustrates one example of a new type of a visualization, comprising a comparison chart that also corresponds to the same dimension or context of programmer bugs (i.e., a feature dimension). This visualization was automatically generated and displayed in response to user input directed at the visualizations or menu shown in FIG. 5. This visualization completely replaces the visualizations that were previously shown, such that they were transient (particularly since the user never fully removed the second visualization from the analysis view).

In FIG. 6, the comparison chart visualization shows the magnitude of bugs associated with Bob, relative to the average developer. The dimensions or scope of these comparisons can be defined automatically in response to predetermined settings and/or profile data. The dimensions or scope of the comparisons can also be defined manually, such as when the user selected an option from menu 660 and/or menu 662.

In some embodiments, as shown, two or more different menus may be provided to enable a user to tune different aspects and dimensions of the visualization. In this case, a first menu 660 enables a user to select a general dimension, whereas the second menu 662 enables a user to select a subset of the general dimension.

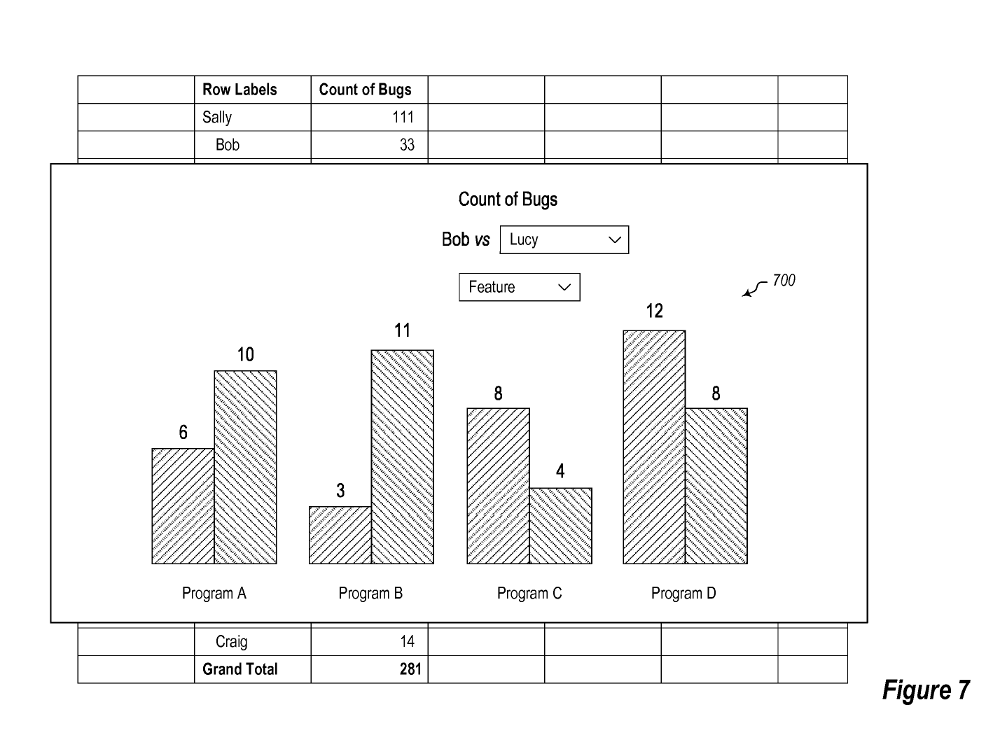

By way of example, FIG. 7 illustrates a visualization of a comparison chart corresponding to bugs associated with Bob and Lucy. Lucy was selected from the pulldown menu in FIG. 6, to automatically create this visualization. In other embodiments, this visualization is automatically created in response to a swipe or other input directed at the visualization of FIG. 6. For instance, a user can swipe the comparison chart of FIG. 6 horizontally or vertically to drill up or down in granularity between different visualizations.

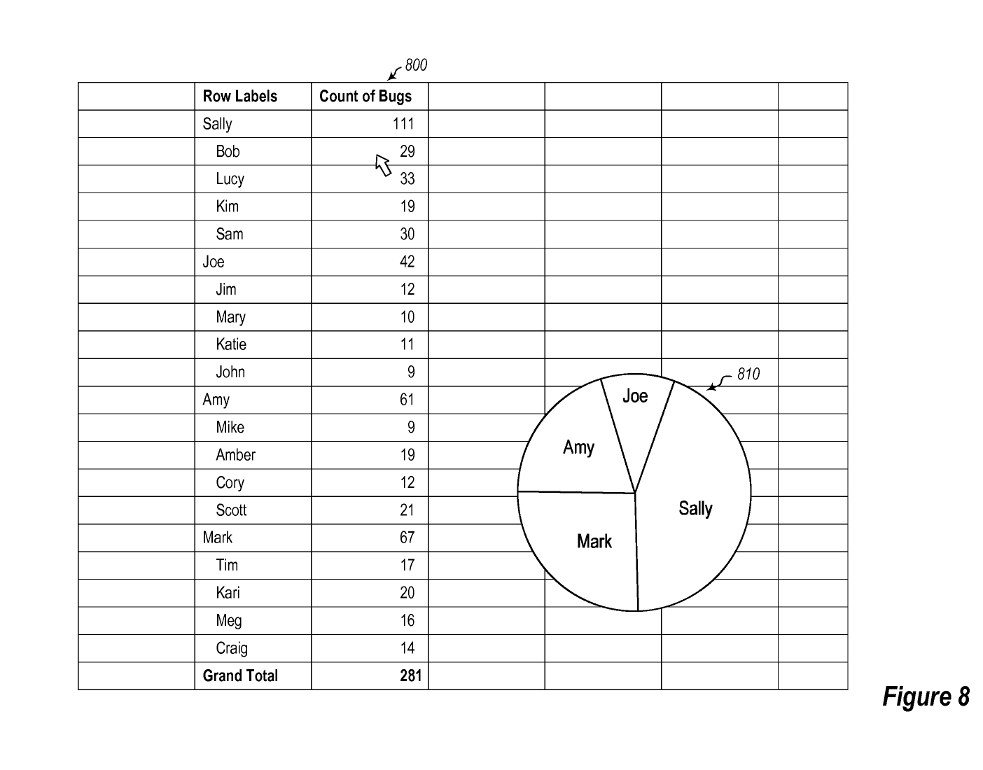

FIG. 8 illustrates yet another embodiment of a pivot table 800 and a corresponding analysis view visualization (e.g., pie chart 810), which is presented next to a corresponding pivot table 800. The illustrated pie chart 810 illustrates a relative magnitude of bugs associated with each programming supervisor. Notably, however, the analysis view window is not illustrated because it was been closed by a user. Nonetheless, the visualization continues to persist, because it was moved out of the boundaries of the analysis view window prior to the analysis view being closed.

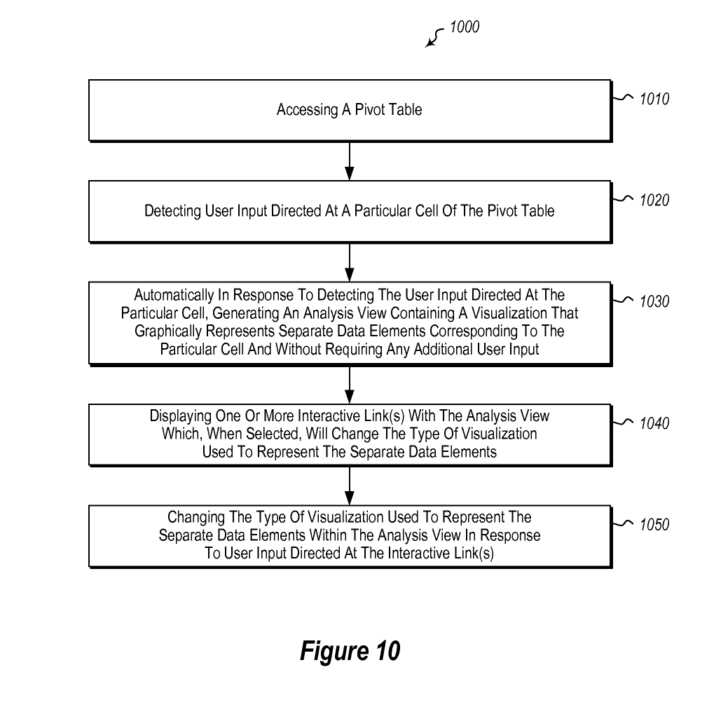

Attention is now directed to FIG. 10, which illustrates another flowchart of a method for creating and using an analysis view. In this embodiment, the computing system is used to access a pivot table (act 1010). Then, user input is detected at a particular cell of the pivot table (act 1020). In response to this input, the analysis view is automatically generated (without requiring any additional user input, such as user navigation through a chart/graphics wizard) to visualize content corresponding to separate data elements associated with the selected cell (act 1030). The system may do this by parsing or otherwise decomposing the constituent parts of the data field. In some instances, this includes referencing the original data directly from the spreadsheet.

The computing system also displays one or more interactive links with the analysis view which, when selected, causes the computing system to change the type of visualization(s) used to represent the content of the corresponding separate data elements (act 1040). The computing system then changes the type of visualization used (act 1050).

By way of example, the pulldown menus described above, with regard to FIGS. 3-8, can comprise interactive links that are each operable to trigger a change in the type of visualization(s) used. The visualizations themselves can also comprise these interactive links, such as, for example, by enabling a user to select and/or swipe a visualization to change the type of visualization(s) used.

In another embodiment, shown in FIG. 11, the computing system displays a visualization with an analysis view window (act 1110). Notably, this process can also include automatically determining which particular type of visualization should be used, from a plurality of different types of possible visualizations, and without requiring user input defining the particular type of visualization to use.

In some instances, this is accomplished by the computing system detecting a context of the data contained in the plurality of separate data fields. In other embodiments, this includes detecting a quantity of separate data fields that are being summarized and visualized. In yet other embodiments, this may include referencing a user profile to determine a user preference or historical pattern.

The display of the visualization (act 1110) may also be a supplemental display, which occurs after a previous visualization was already rendered in the analysis view. For instance, as described in reference to FIG. 5, multiple visualizations can be rendered within the analysis view window. In some instances, this occurs when a user selects an object rendered in the analysis view window, such as another graphic or link.

In alternative embodiments, the selection of a graphic in an analysis view window can cause a new visualization to replace a previous visualization, by drilling up or down in the level of granularity in which the underlying data associated with the pivot table data is rendered by the new visualization.

After the visualization is rendered, and in response to detecting a user input directed at the analysis view window that is operable to close the analysis view window (act 1020), the computing system then closes the analysis view window and the visualization without requiring additional user input to separately close the visualization (act 1030). According to this embodiment, as discussed above with reference to FIGS. 3-8, the visualization no longer persists when the analysis view window is closed.

In other embodiments, the system first detects user input that is operable to move the visualization out of the analysis view window (act 1040) before the analysis view window is closed. Then, after the visualization is moved out of the analysis view window (act 1050), and after additional user input is detected that is operable to close the analysis view window (act 1060), the system closes the analysis view window. But, this is accomplished without closing the visualization, such that the visualization persists after the analysis view window is closed (act 1070). Similar embodiments to this were discussed above with regard to FIGS. 5 and 8.

It will be appreciated that foregoing aspects of the disclosed embodiments can be used to facilitate the creation and use of an analysis view for interfacing with pivot tables in such a way as to help address some of the technical problems that are typically associated with pivot table interfacing, as described above.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims. Accordingly, all changes which come within the meaning and range of equivalency of the claims are to be embraced within their scope.

What is claimed is:

1. A computing system comprising:
at least one processor; and
at least one storage device having stored computer-executable instructions which, when executed by the at least one processor, implement a method comprising:
accessing a document containing a plurality of populated data fields;
detecting user input directed at a particular data field of the plurality of populated data fields;
determining that the particular data field comprises an aggregate value representing data from a plurality of separate data fields; and
upon determining that the particular data field comprises the aggregate value, automatically generating a visualization that graphically reflects content from the plurality of separate data fields.

2. The computing system of claim 1, wherein the document comprises a pivot table containing the plurality of populated data fields, each of the plurality of populated data fields in the pivot table comprising a separate cell, such that the user input is directed at a particular cell of the pivot table.

3. The computing system of claim 1, wherein the method further includes rendering the visualization in an analysis view window automatically in response to detecting that the user input is a predetermined gesture associated with the rendering of the visualization, the visualization decomposing and graphically representing at least some of the content from the plurality of separate data fields that are associated with the aggregate value.

4. The computing system of claim 3, wherein the gesture comprises hovering a cursor over the particular data field.

5. The computing system of claim 3, wherein the gesture comprises a double click of a cursor positioned over the particular data field.

6. The computing system of claim 3, wherein the gesture comprises a selection of a visualization icon or menu option that is automatically presented in response to detecting a cursor positioned over the particular data field.

7. The computing system of claim 3, wherein the method further includes automatically determining which particular type of visualization should be used, from a plurality of different types of possible visualizations, and without requiring user input defining the particular type of visualization to use.

8. The computing system of claim 7, wherein the determining which particular type of visualization to use is based on a detected context of the data contained in the plurality of separate data fields.

9. The computing system of claim 7, wherein the determining which particular type of visualization to use is based on a detected quantity of the plurality of separate data fields.

10. The computing system of claim 7, wherein the determining which particular type of visualization to use is based on a detected user profile.

11. The computing system of claim 7, wherein the particular type of visualization is a decomposition chart.

12. The computing system of claim 7, wherein the particular type of visualization is a comparison chart.

13. The computing system of claim 3, wherein the method further includes displaying the visualization with a plurality of selectable objects which are operable, when selected, to change the content that is visualized.

14. The computing system of claim 3, wherein the method further includes displaying the visualization with a plurality of selectable objects which are operable, when selected, to change a dimension or granularity of data decomposition and visualization associated with the content.

15. The computing system of claim 1, wherein the visualization is initially presented in an analysis view window, and wherein the visualization includes at least one selectable and transient object that is configured for being selected and dragged out of the analysis view window and which persists even after the analysis view window is closed.

16. A computer implemented method comprising:
detecting user input directed at a particular cell of a pivot table, the particular cell containing a value representing a plurality of separate data elements; and
automatically in response to detecting the user input, performing the following:
identifying the separate data elements; and
generating a visualization that graphically represents the separate data elements with a plurality of corresponding display elements without requiring any additional user input.

17. The method of claim 16, wherein the visualization comprises at least one visualization type selected from a grouping including a decomposition chart, a comparison chart, a pie chart, a trend line or a scatter plot.

18. The method of claim 17, wherein the method further includes detecting a context associated with the separate data elements and selecting the at least one visualization type based on the context.

19. A computer program product comprising at least one storage device having stored computer-executable instructions which, when executed by at least one processor of a computing system, implement a method comprising:
detecting user input directed at a particular cell of a pivot table, the particular cell containing a value representing a plurality of separate data elements; and
automatically in response to detecting the user input, performing the following:
identifying the separate data elements; and
generating a visualization that graphically represents the separate data elements with a plurality of corresponding display elements without requiring any additional user input.

20. The computer program product of claim 19, wherein the method further includes detecting a context associated with the data and determining which of a plurality of different visualization types should be used for generating the visualization.
